(19) United States
(12) Patent Application Publication
(10) Pub. No.: US 2013/0339225 A1
(43) Pub. Date: Dec. 19, 2013

(54) SYSTEM AND METHOD FOR AUTOMATED PURCHASING WITHIN A BUDGET

(71) Applicant: Philip Lockhart, Frisco, TX (US)

(72) Inventor: Philip Lockhart, Frisco, TX (US)

(21) Appl. No.: 13/918,831

(22) Filed: Jun. 14, 2013

Related U.S. Application Data
(60) Provisional application No. 61/660,410, filed on Jun. 15, 2012.

(51) Int. Cl. G06Q 40/00

(52) U.S. Cl. CPC G06Q 40/00
USPC 705/39

(57) ABSTRACT

The disclosed embodiments include a method, apparatus, and computer program product for automated purchasing within a budget. For example, in one embodiment, a method for performing an online transaction is disclosed that includes receiving information regarding the online transaction, receiving a budget amount associated with the online transaction, performing a search based on the information and the budget amount, and displaying results of the search to a user.

### CROSS REFERENCE TO RELATED APPLICATIONS

This application claims priority to U.S. Provisional Patent Application Ser. No. 61/660,410 filed Jun. 15, 2013 entitled SYSTEM AND METHOD FOR AUTOMATED PURCHASING WITHIN A BUDGET, the entire teachings of which are incorporated herein.

### BACKGROUND OF THE INVENTION

The present invention relates generally to the field of applications for computing devices, such as mobile phones, personal digital assistants, personal computers, laptops, portable media players and the like, and more particularly to a system and method for automated purchasing within a budget.

Electronic commerce, commonly known as e-commerce or online shopping, is a type of industry where buying and selling of product or service is conducted over electronic systems such as the Internet and other computer networks. The largest of these online retailing corporations are eBay® and Amazon.com®, both based in the United States. Retail success is no longer all about physical stores, this is evident because of the increase in retailers now offering online store interfaces for consumers. With the growth of online shopping, comes a wealth of new market footprint coverage opportunities for stores that can appropriately cater to consumer demands.

However, a problem with online shopping, as well as offline shopping, is that consumers sometimes forget to stay within their budget. Also, there's no easy way for a consumer to shop for multiple people or for multiple gifts without having to do their own calculations/determination as to whether they are staying within their budgeted amount.

Accordingly, the disclosed embodiments seek to provide a system, method, and computer program product for enabling automated purchasing within a budget.

### BRIEF SUMMARY OF THE INVENTION

The disclosed embodiments include a method, apparatus, and computer program product for performing automated purchasing within a budget. For example, in one embodiment, a method for performing an online transaction is disclosed that includes receiving information regarding the online transaction, receiving a budget amount associated with the online transaction, performing a search based on the information and the budget amount, and displaying results of the search to a user.

Additional embodiments, advantages, and novel features are set forth in the detailed description.

### BRIEF DESCRIPTION OF THE DIAGRAMS

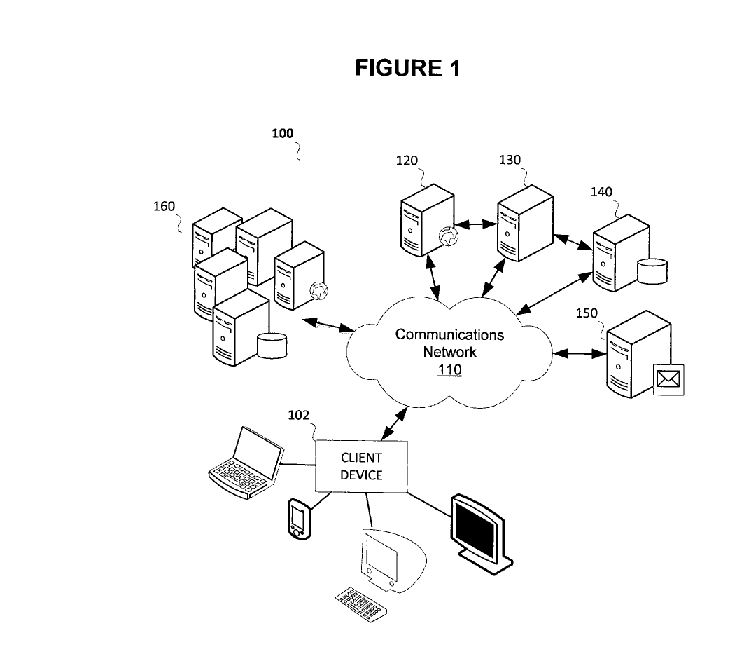

FIG. 1 is a schematic diagram illustrating a network environment in accordance with an embodiment of the invention;

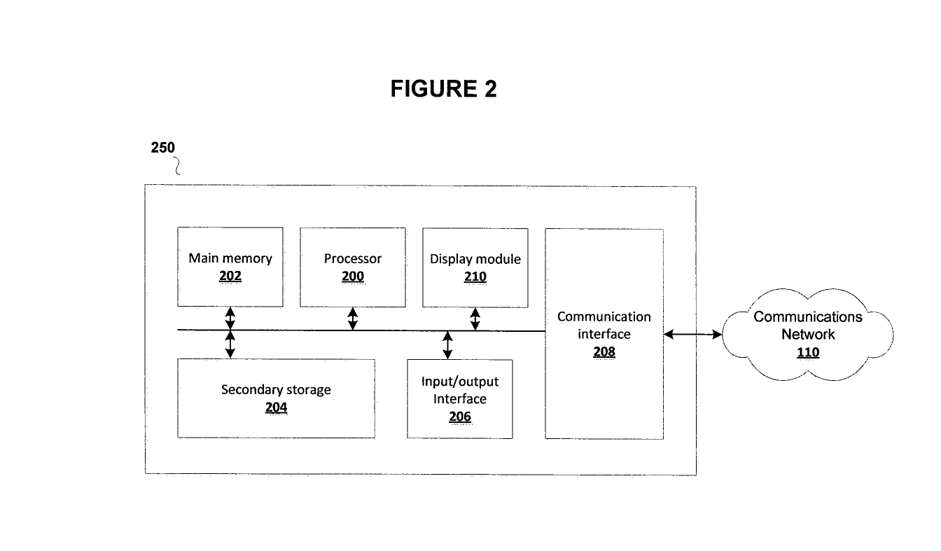

FIG. 2 is a schematic diagram illustrating a device in accordance with an embodiment of the invention;

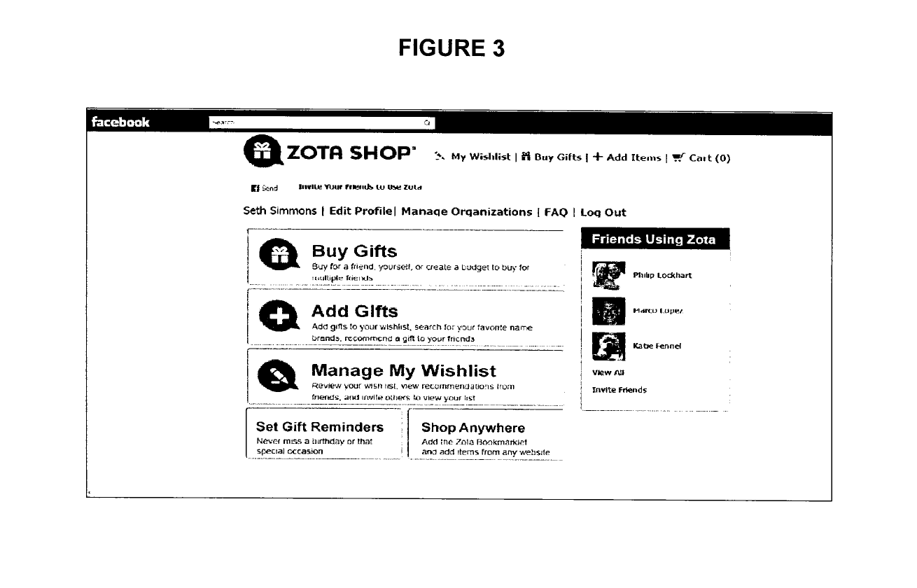

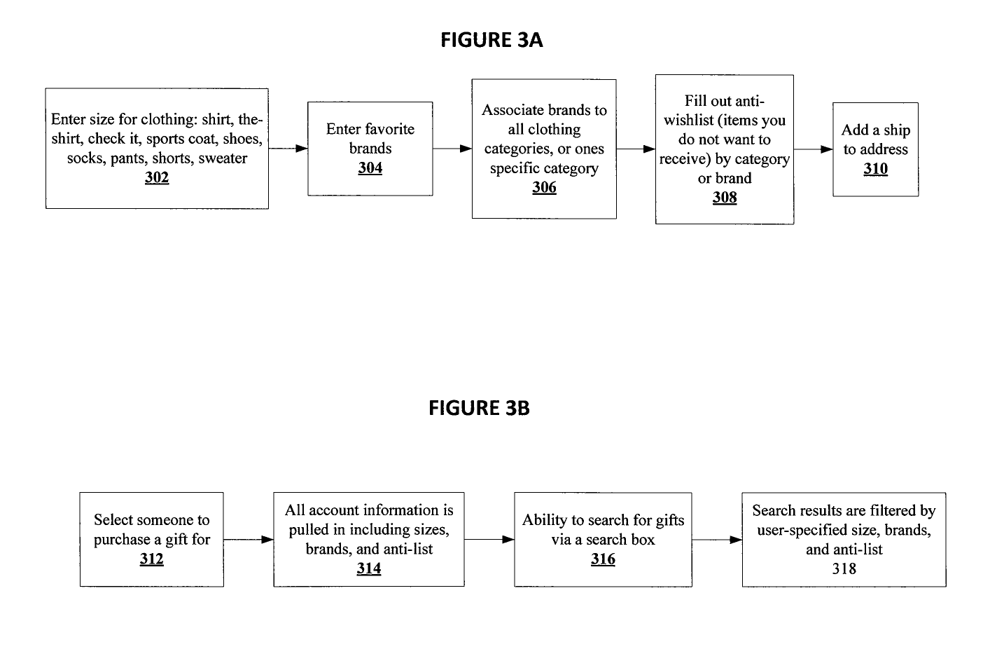

FIG. 3 is a diagram illustrating a user interface of an application in accordance with an embodiment of the invention;

FIG. 3A illustrates a flowchart that depicts a process for specifying user-preferences in accordance with an embodiment of the invention;

FIG. 3B illustrates a flowchart that depicts a process for retrieving a user profile in accordance with an embodiment of the invention;

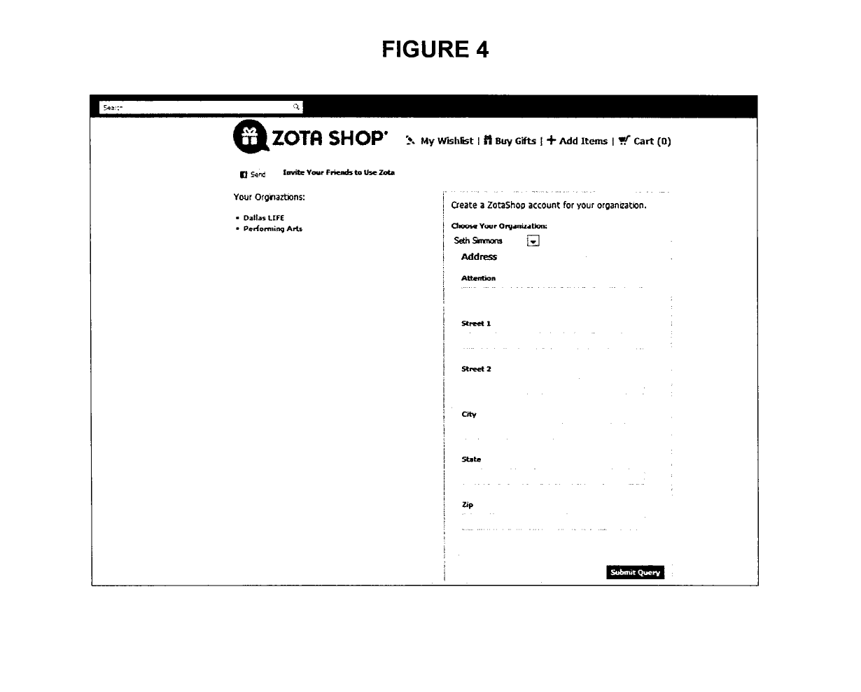

FIG. 4 is a diagram illustrating an account setup page in accordance with an embodiment of the invention;

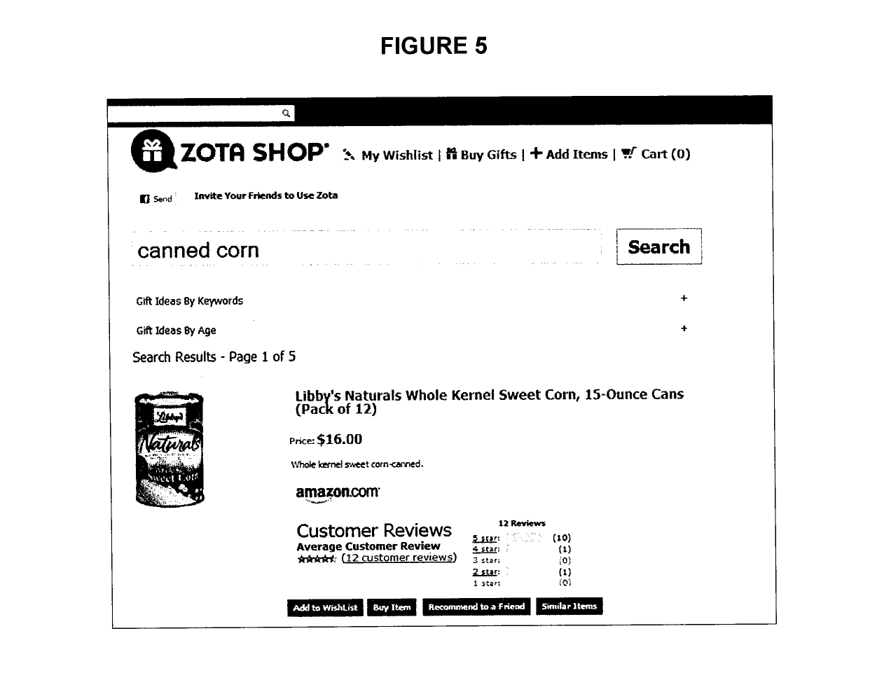

FIG. 5 is a diagram illustrating a product search page in accordance with an embodiment of the invention;

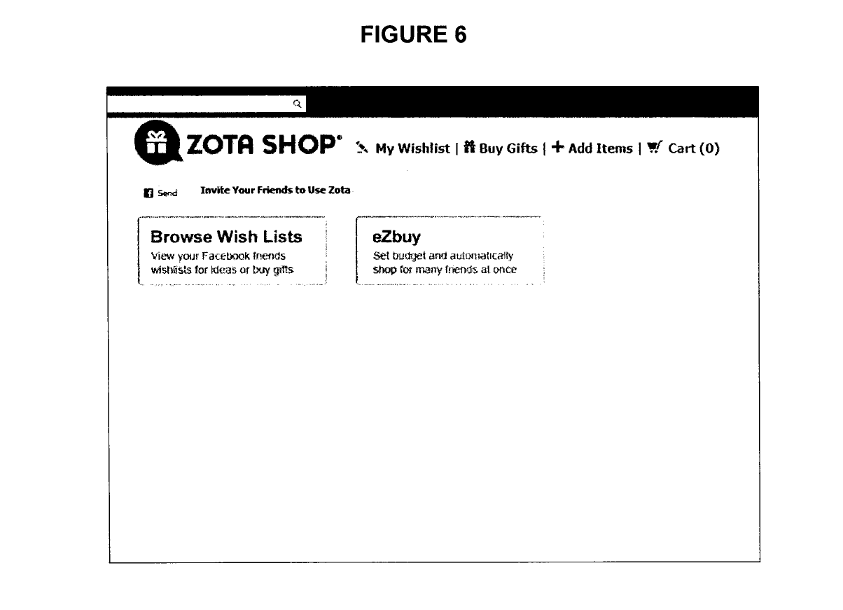

FIG. 6 is a diagram illustrating a couple of options in accordance with an embodiment of the invention;

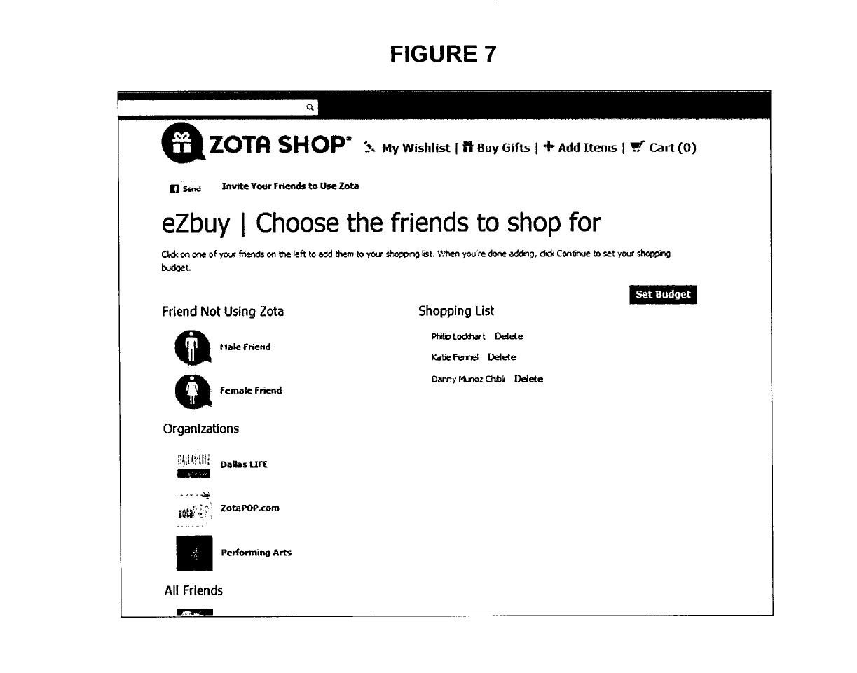

FIG. 7 is a diagram illustrating a user interface for selecting one or more friends and/or organizations to shop for in accordance with an embodiment of the invention;

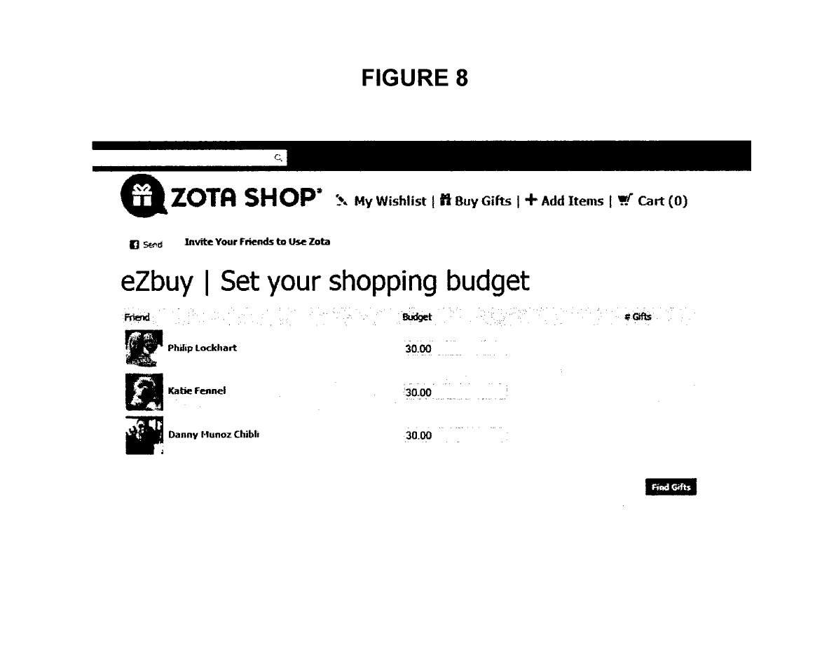

FIG. 8 is a diagram illustrating a user interface for entering budget amounts in accordance with an embodiment of the invention;

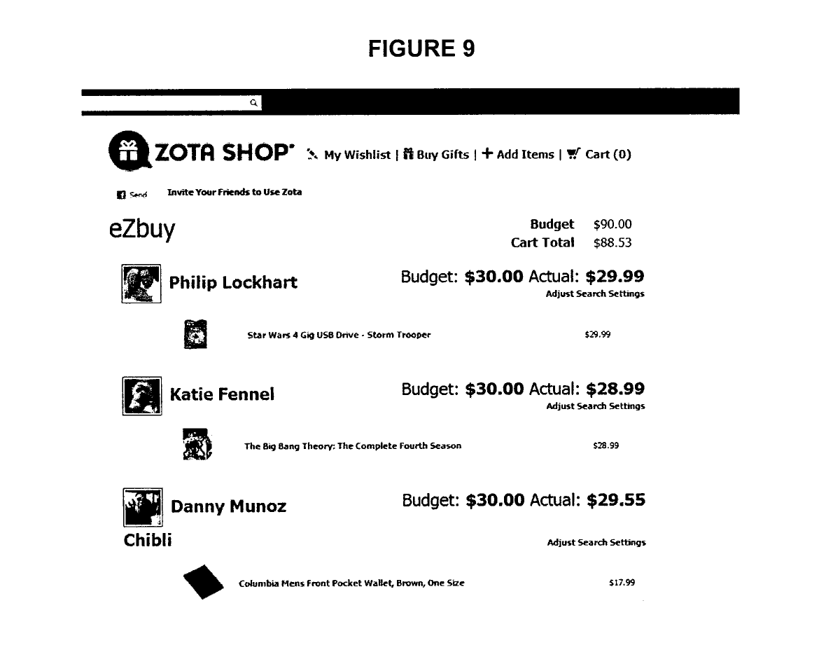

FIG. 9 is a diagram illustrating a user interface that displays selected items based on the budgeted amounts in accordance with an embodiment of the invention;

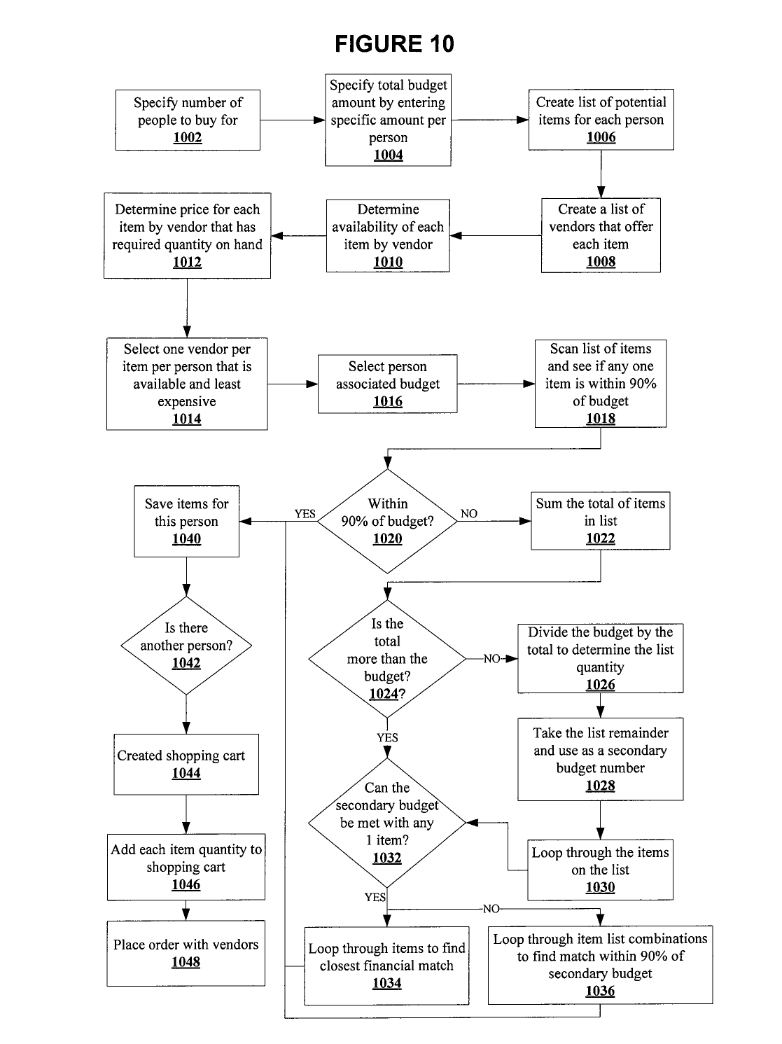

FIG. 10 illustrates a flowchart that depicts a process for automated shopping based on a budget in accordance with one embodiment; and

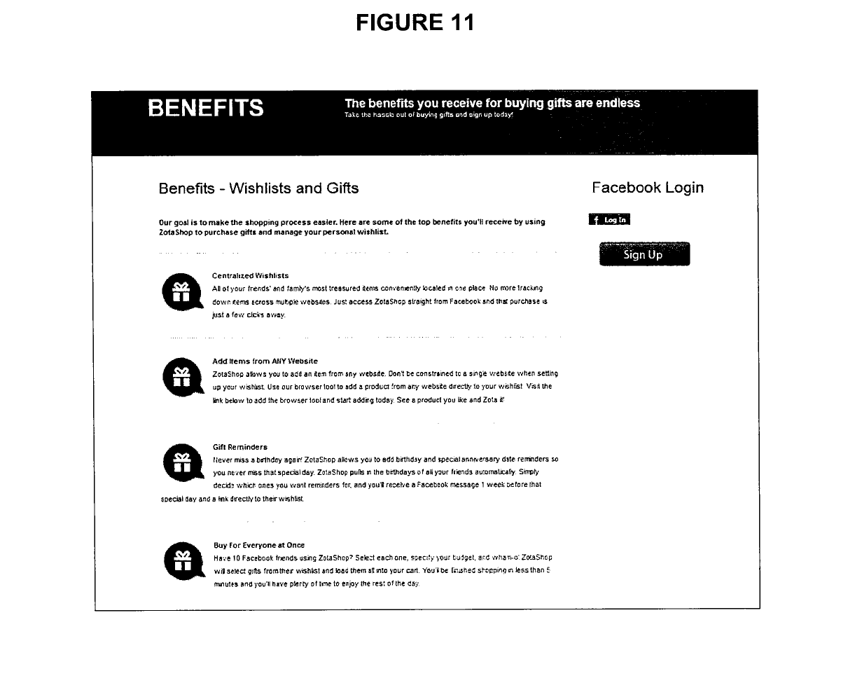

FIG. 11 is a diagram illustrating some of the benefits of utilizing the disclosed embodiments.

### DETAILED DESCRIPTION

The disclosed embodiments may assist a user in budgeting, ordering, and/or finding the least expensive options for automated purchasing within a budget. The disclosed embodiments and advantages thereof are best understood by referring to FIGS. 1-11 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and not intended to assert or imply any limitation with regard to the environment, architecture, design, or process in which different embodiments may be implemented.

FIG. 1 depicts an embodiment of a network environment 100 in which certain illustrative embodiments may be implemented. The network environment 100 includes a communications network 110 that enables a plurality of devices including a user device 102 to communicate data with other devices connected to the communications network 110. The communications network 110 may be any type of network including a combination of one or more of the following networks: a wide area network, a local area network, one or more private networks, the Internet, a telephone network such as the public switched telephone network (PSTN), one or more cellular networks, and wireless data networks. The communications network 110 may include a plurality of network nodes (not depicted) such as routers, network access points/gateways, switches, DNS servers, proxy servers, and other network nodes for assisting in routing of data/communications between devices.

In the depicted embodiment, the communications network 110 may provide data communications between one or more client devices such as a client device 102 and one or more server devices for enabling a user to perform the features and functions of the disclosed embodiments including, but not limited to, creating wish lists, searching for items to add to a wish list, reviewing the wish lists of others, setting a budget (per person and total), automatically search/generate a list of items for one or more people/organizations based on the user's budget, and automatically purchase all the items on the list.

The client device 102 may be any type of device operable to communicate with the one or more servers over the communications network 110. For example, the client device 102 may be a laptop computer, a mobile phone or tablet, a desktop computer, a wired phone, a television, a set-top box, and/or any other device operable to communicate with the one or more servers over the communications network 110 for enabling a user to perform the features and functions of the disclosed embodiments.

The one or more servers may include one or more Web servers 120, Back-End servers 130, Database servers 140, and Mail servers 150. For example, in one embodiment, a user using the client device 102 interacts with a web site hosted by a Web server 120 in order to access the user's wish list and review the wish list of others. The client device 102 may interact with the Web server 120 utilizing a web browser application. Alternatively, the client device 102 may interact with either the Web server 120 or directly with another server device via an application installed on the client device 102 specially configured to enable to perform the features and functions of the disclosed embodiments. For instance, in some embodiments, a user's mobile device may be configured to include a mobile application and/or a user may download an application and install it on his/her personal computer.

In some embodiments, a Web server 120 may utilize one or more Back-End servers 130 to perform the features and functions of the disclosed embodiments. For example, the Back-End servers 130 may perform the actual query searches and provide the results to the Web server 120. The Web server 120 then formats the results into a format that is presentable to the user. Advantages of this configuration include the one or more Back-End servers 130 being able to serve multiple Web servers 120, easier management by splitting the interface code from the labor intensive code, and generally faster processing capabilities of the Back-End servers 130.

The Web server 120 and Back-End servers 130 may also utilize one or more Database servers 140. For example, in one embodiment, the Database servers 140 may store all the user account information data such as, but not limited to, information about user's wish list, information about the user's friends, previous purchases, such as how much was spent for a particular person and which items were purchased or which persons. The Database servers 140 may also store user information such as, but not limited to, a user profile, username, addresses, contact information, user preferences, and user billing information. The Web server 120 and/or Back-End servers 130 may also communicate with one or more communications servers such as, but not limited to, a Mail server 150, an SMS server (not depicted), and a fax server for sending and receiving communications.

In one embodiment, the Web servers 120, Back-End servers 130, and Database servers 140 may communicate over the communications network 110. This communication may be over the Internet and/or over a private network. In some embodiments, one or more of the above server devices may be directly wired to each other to provide direct communications between the devices. Still, in some embodiments, a single server/device may be configured to perform all of the features and functions of the disclosed embodiments.

In accordance with the disclosed embodiments, the one or more servers (120-140) may interact with any number of other computing devices 160 (e.g., other servers, mainframe, databases, etc.) over the communications network 110 to perform the features and functions of the disclosed embodiments. For instance, in accordance with one embodiment, the one or more servers (120-140) may interact with one or more servers hosting a social networking site, such as, but not limited to, Facebook®. For example, the disclosed embodiments may be implemented as a Facebook® application that is tied to Facebook® for enabling a user to recommend particular items to a friend, view a friend's wish list, post suggested or purchased items on a user's Facebook wall, and review the Facebook information about a particular organization.

FIG. 2 depicts a schematic diagram illustrating some components of a server device 250 in accordance with the disclosed embodiments may be utilized to perform the features and functions of the disclosed embodiments. The server device 250 includes a processor 200, main memory 202, secondary storage unit 204, an input/output interface module 206, and a communication interface module 208. The processor 200 may be any number of or type of processors capable of executing instructions for performing the features and functions of the disclosed embodiments.

The input/output interface module 206 enables the server device 250 to receive user input and output information to a user or other devices. In some embodiments, the input/output interface module 206 also provides audio and video capabilities. The input/output interface module 206 may also enable external devices such as printers, USB flash drive, speakers, to be connected to the server device 250.

The communication interface module 208 enables the server device 250 to communicate with the communications network 110. For example, the network interface module 208 may include a network interface card for hardwiring the server device 250 to the communications network 110. In one embodiment, the communication interface module 208 may also include a wireless data interface for enabling the server device 250 to communicate wirelessly through a wireless access point or via a wireless network with the communications network 110. In some embodiments, the communication interface module 208 may also include a radiofrequency transceiver for sending and receiving cellular signals for voice communications.

In some embodiments, the server device 250 may optionally include a display module 210 to enable information to be displayed on an internal or external display device. For instance, the display module 210 may include instructions or hardware for providing touchscreen capabilities for receiving user input via the display device. In certain embodiments, the display module 210 may also include instructions for enabling multi-touch functionalities associated with a display device.

Main memory 202 is volatile memory that stores currently executing instructions/data, or instructions/data that are prefetched for execution. The secondary storage unit 204 is non-volatile memory for storing persistent data. The secondary storage unit 204 may be or include any type of data storage component such as a hard drive, a flash drive, or memory card. In one embodiment, the secondary storage unit 204 stores the computer executable code/instructions and other relevant data for enabling a user to perform the features and functions of the disclosed embodiments.

For example, in accordance with the disclosed embodiments, the computer executable code/instructions include, but not limited to, instructions for generating a user interface, instructions for parsing information received from a user, instructions for enabling a user to create a user account, create one or more wish lists, associate friends/organizations wish lists with the user's account, set a budget for purchasing gifts to the one or more associated friends/organizations, automatically search/generate a list of items for a selected one or more friends/organizations that satisfy the user's budget, and automatically purchase every item on the list and have it shipped to the one or more friends/organization's. These instructions are passed from the secondary storage unit 204 to main memory 202 for enabling execution by the processor 200.

As an example, FIG. 3 depicts a diagram illustrating a user interface of an application in accordance with an embodiment of the invention. The depicted user interface includes options for buying gifts; viewing or modifying a wish list; viewing recommendations from others; inviting others to view your wish list; setting gifts reminders for birthdays, anniversary, and any other special occasion; editing your user profile; and managing a list of organizations. The user interface may also include a list of current friends that utilize the disclosed embodiments and an option for inviting more friends to utilize the disclosed embodiments.

As will be further discussed, the buying option enables a user to buy a gift for a single friend, a group of friends, the user, and an organization all based on a predetermined budget amount. The add gifts option enables a user to add gifts to their wish list, recommend a gift/item to one or more friends, and search for a particular product. In one embodiment, the disclosed embodiments may be linked to one or more retailers (e.g., Amazon.com®) for enabling a user to search and add items directly from the one or more retailers into the user's wish list.

Additionally, in certain embodiments, the disclosed application may include an option for enabling a user to add an item from any online retailer/website into the user's wish list. For instance, this option may include computer executable instructions for capturing any online retailer's web address, a URL to a direct page containing the item, an image of the item, the cost of the item, and be able to add all this information directly into the user's wish list.

In addition, in reference to FIG. 3A, in some embodiments, the disclosed embodiments are configured to enable people to specify clothing sizes, color preferences (302), brand preferences (304), a ship to address where they want gifts to be sent (310), and even an anti-wishlist of product categories or brands they never wish to receive (308). The user can associate the brand preferences to all categories, or one or more specific categories (306). For example, the user may like Nike® shoes, but not their clothing, hats, or sporting equipment. This allows another user, as depicted in FIG. 3B, to select a person's profile (312) to look up clothing sizes, brand preferences, and other user specified preferences very quickly (314). The person can also do custom searches using a search mechanism (316) that applies the clothing, brand, and anti-wishlist preferences to filter out results that do not apply. For example, when searching for a friend, the user could specify shirt and the results would know that the size is medium, favorite color is blue, and Ralph Lauren® shirts are his favorite and only show results that match that request (318).

FIG. 4 is a diagram illustrating an account setup page in accordance with an embodiment of the invention. In the depicted embodiment, the user may set up an organization (e.g., a nonprofit) by creating an account for the organization. Once the account is set up, the user may populate the wish list of the organization for enabling donors to donate particular item to the organization.

FIG. 5 is a diagram illustrating a product search page in accordance with an embodiment of the invention. In the disclosed embodiments, the user may type in any search string for finding a desired product. In certain embodiments, in addition to keyword searching, a user may search for gifts ideas based on the age of the recipient. As stated above, the search query may be tied to one or more online retailer database such as, but not limited to, Amazon.com®. Once a desired product is located, a user may add it to their wish list, buy the particular item, recommend it to a friend, or search for similar items.

FIG. 6 is a diagram illustrating a couple of options in accordance with an embodiment of the invention. In the depicted embodiment, a user may browse the wish list of their social networking friends for gift ideas or for purchasing one or more items for one or more of their social networking friends based on their respective wish list. In addition, the disclosed embodiment depicts an option for the user to set a budget and to automatically shop for many friends simultaneously based on the predetermined budget.

For example, FIG. 7 is a diagram illustrating a user interface for selecting one or more friends and/or organizations to shop for in accordance with an embodiment of the invention. In the depicted embodiment, once a selected number of friends have been added to a shopping list, the user can proceed to set a budget.

As an example, FIG. 8 is a diagram illustrating a user interface for entering budget amounts in accordance with an embodiment of the invention. In the depicted embodiment, an actual budget amount may be entered for each friend in the shopping list. In certain embodiments, a number of gifts may also be entered for each respective friend in the shopping list. For example, one friend may receive 2 gifts, while the other friends only each receive a single gift. In an alternative embodiment, the user may set a total budget and allocate percentages of the budget to each friend in the shopping list. For example, one friend may be allocated 25% of the total budget, another may be allocated 45% of the total budget, and the last one may receive a remaining percentage. Once the budget information is received, the disclosed embodiments will query each of the friends' respective wish list items and automatically generate a list of items for each of the friends based on the allocated budget amount.

For example, FIG. 9 is a diagram illustrating a user interface that displays selected items based on the budgeted amounts in accordance with an embodiment of the invention. In the depicted embodiment, the total budgeted amount is $90. The shopping list includes 3 friends that are each allocated a budget of $30. Based on their respective wish list, the disclosed embodiments generated the suggested illustrated items for each of the friends. In this embodiment, the budget for each friend is displayed along with the actual amount for each item. In one embodiment, the user interface includes an option to search for alternative items for each individual friend in the shopping list. The alternative search option may be performed simultaneously for every friend within the shopping list or may be done on a per individual basis.

Referring now to FIG. 10, a flowchart that depicts a process for automated shopping based on a budget in accordance with one embodiment is presented. As seen in the flowchart, a number of people to purchase items for are first specified (1002). A total budget amount and/or budget amount per individual is specified (1004). This may be an actual dollar amount or may be a percentage of the total amount. A number of gifts may also be specified for each of their respective friends and shopping list.

The process then performs a query of each individual's respective wish list items to create a list of potential items for each person (1006). The process then creates a list of vendor that offers each item (1008) and determines the availability (1010) and pricing of each item by each vendor (1012). The process then selects the vendor per item per person that is available and is least expensive (10014).

Process then proceeds to each person on the shopping list and reviews budget associated with each person (1016). The process then scans the list of items to see if any one item is within 90% of the budget for any particular person (1018). If an item is within 90% of a budget for a particular person (1020), the process will save that item for the particular person (1022) and will advance to selecting an item for another person within the shopping list (1024). Although 90% is utilized in the above description, the disclosed embodiments may utilize any percentage amount.

However, if the process determines that there is not any one item is within 90% of the person's budgeted amount (1020); the process sums the total of the items in the list (1022) and determines if the total is more than the budgeted amount (1024). If the total is not more than the budgeted amount, the process divides the budgeted amount by the list total to determine the list quantity (1026). The process takes the list remainder and uses it as a secondary budget number (1028). The process loops through the items on the items list (1030) to determine if the secondary budgeted amount is met by any one item in the list (1032) and if so, the process loops through the items to find the closest matching item equaling the secondary budgeted amount (1034). The process then saves this particular item for this particular person (1040). If the secondary budgeted amount is not met by any one item in the list (1032), then the process will loop through combinations within the items list to find a match within 90% of the secondary budgeted amount (1036). The process then saves the matching combination of items for this particular person (1040). In one embodiment, if there are not enough items on the wish list to fulfill the budgeted amount, the remainder will be filled with a gift card.

Once the above process has completed for each friend/organization within the shopping list, the process will create a shopping cart (1044) listing each of the friend/organization and their respective matching items (1046). The user may then edit the shopping cart by removing items, replacing items, and/or changing the quantity of items in the shopping cart. Once a user is satisfied, the user may place the order and the process automatically places the order for each of the items in the shopping cart with each of the respective vendors (1048), have them shipped directly to the recipients (if so desired by the user), and bill the user for the ordered amount.

In some embodiments, the process may also be bill a vendor or perform other accounting features based on the sale. For example, the process may perform an accounting feature to account for a certain percentage of the sale as a commission for generating the sale with a partnered vendor.

FIG. 11 is a diagram illustrating some of the benefits of utilizing the disclosed embodiments. Advantages of the disclosed embodiments include, but are not limited to, making the shopping/gift buying process easier by providing centralized wish lists, the ability to add any online item to a user's wish list, by providing gift reminders, and by enabling automatic purchasing for one or more people/organizations based on a predetermined budgeted amount.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible non-transitory apparatus that can store the program for use by or in connection with a system or electronic device.

The previous detailed description is of a small number of embodiments for implementing the invention and is not intended to be limiting in scope. For example, while specific details about the above embodiments have been described, the above hardware and software descriptions are intended merely as example embodiments and are not intended to limit the structure or implementation of the disclosed embodiments.

In addition, those skilled in the art will recognize that the present teachings are amenable to a variety of modifications and/or enhancements. While the foregoing has described what is considered to be the best mode and/or other examples, it is understood that various modifications may be made therein and that the subject matter disclosed herein may be implemented in various forms and examples, and that the teachings may be applied in numerous applications, only some of which have been described herein. Such modifications are intended to be covered within the true scope of the present teachings.

In addition, the flowcharts, sequence diagrams, and block diagrams in the figures illustrate the architecture, functionality, and operation of possible implementations of systems, methods and computer program products according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to explain the principles of the invention and the practical application, and to enable others of ordinary skill in the art to understand the invention for various embodiments with various modifications as are suited to the particular use contemplated. The scope of the claims is intended to broadly cover the disclosed embodiments and any such modification.

1. A method for performing an online transaction, the method comprising:
receiving information regarding the online transaction;
receiving a budget amount associated with the online transaction;
performing a search based on the information and the budget amount; and
displaying results of the search to a user.

2. The method of claim 1, wherein the information regarding the online transaction comprises selecting one or more previously created profiles of a person or organization in which to purchase at least one item for within the budget amount.

3. The method of claim 2, wherein the previously created profiles of the person or organization specifies items that the person or organization desires.

4. The method of claim 2, wherein the previously created profiles of the person or organization specifies brand preferences that the person or organization desires.

5. The method of claim 2, wherein the previously created profiles of the person or organization specifies items that the person or organization does not desire.

6. The method of claim 2, wherein receiving the budget amount includes receiving a user-specified percentage of the budget amount to spend on an item for the one or more persons or organizations.

7. The method of claim 1, further comprising:
receiving gift reminder data;
receiving a user-specification that the budget amount is a monthly budget amount to spend on all gifts during a particular month; and
automatically selecting and purchasing gifts for one or more person or organization based on the gift reminder data and the monthly budget amount.

8. The method of claim 1, wherein the search is performed using one or more third party vendors.

9. The method of claim 8, further comprising billing a referral fee to a third party vendor in response to completing a transaction that involves one or more items purchased from the third party vendor.

10. The method of claim 2, wherein the previously created profiles of the person or organization specifies items that the person or organization desires, brand preferences that the person or organization desires, and items that the person or organization does not desire, and wherein performing the search based on the information includes filtering the results based on the specified items that the person or organization desires, brand preferences that the person or organization desires, and items that the person or organization does not desire.

11. The method of claim 2, wherein receiving the budget amount includes receiving a user-specified breakdown of the budget amount to spend on each selected person or organization.

12. The method of claim 11, wherein performing the search comprises identifying a single item that is within a specified breakdown amount of the budget amount that satisfies the profiles of the person or organization.

13. The method of claim 1, further comprising donating a leftover amount of the budget amount to a user-specified organization.

14. A system comprising:
memory for storing data and executable instructions;
a processor configured to execute the executable instructions to:
receive information regarding an online transaction;
receive a budget amount associated with the online transaction;
perform a search based on the information and the budget amount; and
display results of the search to a user.

15. The system of claim 14, wherein the information regarding the online transaction comprises selecting one or more previously created profiles of a person or organization in which to purchase at least one item for within the budget amount.

16. The system of claim 15, wherein receiving the budget amount includes receiving a user-specified percentage of the budget amount to spend on an item for the one or more persons or organizations.

17. The system of claim 15, further comprising executable instructions to:
receive gift reminder data;
receive a user-specification that the budget amount is a monthly budget amount to spend on all gifts during a particular month; and
automatically select and purchase gifts for one or more person or organization based on the gift reminder data and the monthly budget amount.

18. The system of claim 15, wherein receiving the budget amount includes receiving a user-specified breakdown of the budget amount to spend on each selected person or organization; and
wherein performing the search comprises identifying items that is within a breakdown amount of the budget amount that satisfies the profiles of the person or organization.

19. The system of claim 15, further comprising executable instructions to donate a leftover amount of the budget amount to a user-specified organization.

20. A non-transitory computer readable medium comprising computer executable instructions that when executed causes one or more machines to perform operations comprising:
receiving information regarding the online transaction;
receiving a budget amount associated with the online transaction;
performing a search based on the information and the budget amount; and
displaying results of the search to a user.
